(19) United States
(12) Patent Application Publication
(10) Pub. No.: US 2002/0020633 A1
(43) Pub. Date: Feb. 21, 2002

(54) Cleaning container for spectacles

(76) Inventor: Olaf Freise, Garmisch-Partenkirchen (DE)

Correspondence Address: Russell W. Pyle, Suite 850, 221 N. LaSalle St., Chicago, IL, 60601, US

(21) Appl. No.: 09/923,988

(22) Filed: Aug. 7, 2001

(30) Foreign Application Priority Data
Aug. 11, 2000 (DE) 100 39 254.7

(51) Int. Cl. B65D 81/22; A45C 11/04; B08B 3/00

(52) U.S. Cl. 206/5; 134/117; 134/201

(57) ABSTRACT

The cleaning container for spectacles comprises a cap and a bellows arranged on the bottom of the cleaning container, the spectacles to be cleaned being adapted to be clamped longitudinally between the cap and the bellows. For mounting the bellows, the circumferential wall of the cleaning container has provided therein a plurality of indentations which are evenly distributed over the circumference and form inwardly projecting noses which grip over the bellows in an axially slightly compressed state. The mounting of the cleaning container is thereby simplified, and the shape of the indentations guarantees that upon axial compression the bellows can always return into the initial state without getting jammed.

### BACKGROUND OF THE INVENTION

The present invention relates to a cleaning container for spectacles, the container comprising a cap as well as a bellows arranged on the bottom of the cleaning container, the spectacles to be cleaned being adapted to be clamped longitudinally between the cap and the bellows.

The bellows is preferably provided on its upper face with a circular hollow for centering the spectacles. For the same purpose a central, dome-shaped depression may be provided in the cap. However, it is also within the scope of the present invention that a further elastic holding member can be arranged for the spectacles on the cap, for instance a body of foamed plastic.

A cleaning fluid is filled into the cleaning container. For cleaning the spectacles it may be sufficient when the spectacles are left for some time in a state where they are immersed in the fluid. The cleaning operation can be shortened by shaking or pivoting the cleaning container, the bellows having the effect that spectacles of different lengths can be gently clamped in the middle of the cleaning container, so that the glasses of the spectacles are prevented from hitting against the circumferential wall of the cleaning container during the cleaning process.

EP 0 231 454 B1 discloses a cleaning container of the above-mentioned type in which a bellows is provided on the bottom side with a fastening connection which is held in a ring web of a disk which, in turn, is pressed into a ring-like bead of the bottom of the cleaning container. This way of fastening the bellows is troublesome and entails considerable costs.

### SUMMARY OF THE INVENTION

It is the object of the present invention to improve a cleaning container of the above-mentioned type in such a manner that the bellows is held more easily on the bottom of the cleaning container.

The cleaning container according to the invention is equipped on its circumferential wall with a plurality of inwardly protruding projections which grip over an edge section of the bellows. It is here preferred that the projections grip over the edge of the uppermost pleat member of the bellows and that the bellows rests in an axially slightly compressed state on radially inner holding sections of the projections. The projections are at about the same level and are preferably evenly distributed over the circumference of the container. In a preferred embodiment of the invention, six projections of such a type are provided for.

The cleaning container consists of a plastic material such a PP, and it is preferably produced in a blowing process. The bellows preferably consists of a plastic material, such as HDPE (high density polyethylene).

In all horizontal sections, the indentations have an arcuate shape, preferably the shape of a section of a circular arc. In vertical section, the indentations are composed of an upper, arcuate and convexly inwardly extending first section, a subsequent, short and outwardly recessed holding section for the bellows, and a lower arcuate guide section. In cooperation with the outwardly recessed holding section, the first upper section forms a nose which grips over the edge of the bellows. The free inner diameter on the outer end of the holding sections of the indentations is here slightly greater (in the order of a few millimeters) than the outer diameter of the bellows, while the free inner diameter between the “nose tips” is smaller than the outer diameter of the bellows.

The lower arcuate guide sections have such an extension that the free inner diameter gradually increases downwards. The radius of the guide section in a preferred embodiment of the cleaning container is about 50 mm. The upper arcuate section of the indentation may have the same radius, the free space between the first sections getting gradually smaller in said area.

The bellows can be mounted very easily because it must just be pressed downwards along the upper first sections, with the bellows of a relatively soft plastic material moving past the “noses” due to deformation of its pleat members. The bellows will then return into its initial state due to its elasticity while being guided and centered by the lower guide sections of the indentations, so that it comes to rest with its upper edge on the bottom side of the holding sections of the indentations.

When compressed during use, the bellows will always return into the middle, centered initial position—without getting jammed—because of the special indentations.

Further details of the invention will become apparent from the following description of a preferred embodiment of the cleaning container for spectacles.

### BRIEF DESCRIPTION OF THE DRAWINGS

FIG. 1 is a vertical section through the container.

FIG. 2 is a horizontal section through the area of the indentations.

### DETAILED DESCRIPTION

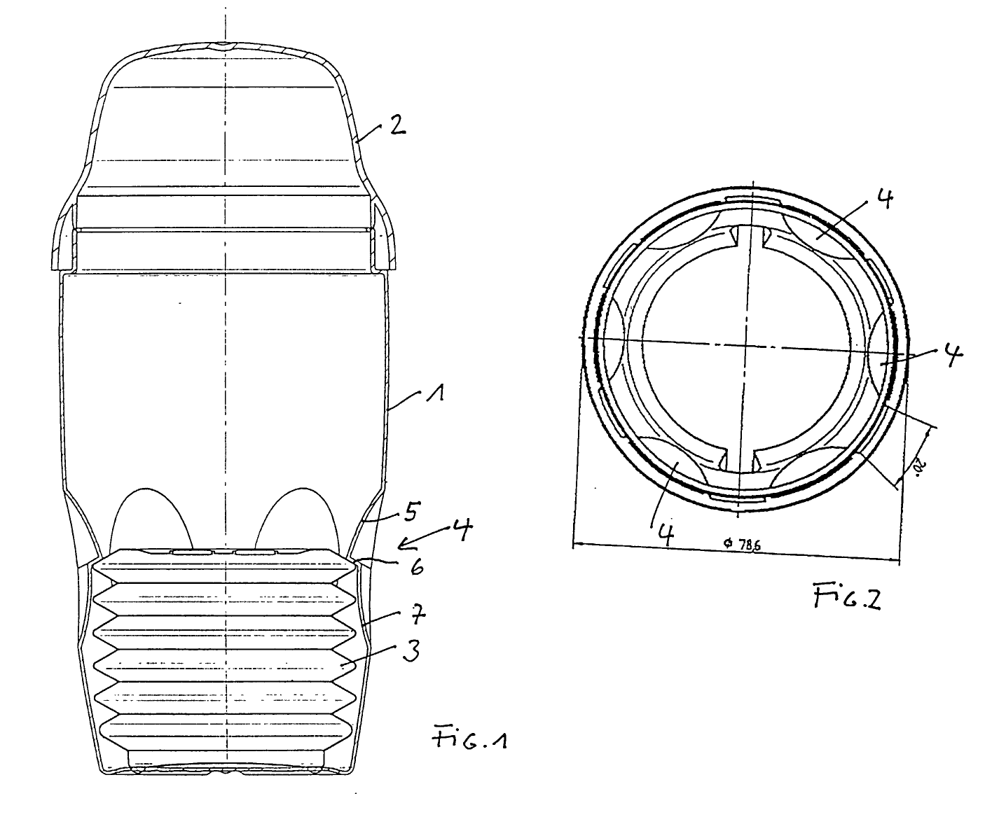

The cleaning container 1 as shown in FIG. 1 comprises a screw-on cap 2 by which the cleaning container 1 can be sealingly closed so that cleaning fluid cannot escape even if the cleaning container is shaken for cleaning a pair of spectacles (not shown). Said spectacles can be clamped in longitudinal direction between the cap 2 and a bellows 3 which is compressed more or less axially, depending on the dimensions of the spectacles.

The cleaning container 1 comprises six indentations 4 that are evenly distributed over the circumference, all of said indentations being at the same level. When viewed in vertical section, said indentations consist of an upper, arcuately curved section 5 which forms a nose together with a subsequent, recessed holding section of a short length. The holding section 6 is followed by a lower arcuate guide section 7 which returns to the outer contour of the cleaning container. Sections 5 and 7 (in vertical section) have the shape of a circular arc with a radius which in a preferred embodiment of the invention is 50 mm. The holding section 6 extends in straight fashion with an inclination of preferably 30° if the inclination of the upper edge of the adjoining bellows has been chosen accordingly.

In all horizontal sections, the indentations 4 have the shape of a circular arc, as shown in FIG. 2.

The bellows rests in slightly axially compressed fashion on the bottom side of the “noses”. When the bellows is axially compressed during use, it is centered by the guide sections 7 while axially expending again, and comes again into contact with the holding sections 6 without getting jammed.

1. A cleaning container for spectacles, comprising a cap and a bellows arranged on the bottom of the cleaning container, the spectacles to be cleaned being adapted to be clamped longitudinally between said cap and said bellows, characterized in that the circumferential wall of said cleaning container (1) has arranged thereon a plurality of inwardly protruding projections (5, 6, 7) gripping over an edge section of said bellows (3).

2. The cleaning container according to claim 1, characterized in that said projections (5, 6, 7) are evenly distributed over the circumference.

3. The cleaning container according to claim 1, characterized in that six projections (5, 6, 7) are formed.

4. The cleaning container according to any one of claim 1, characterized in that said projections are formed by depressions or indentations (4) in said circumferential wall.

5. The cleaning container according to claim 4, characterized in that, when viewed from the top, said indentations have approximately the shape of an ellipse.

6. The cleaning container according to claim 4, characterized in that said indentations (4) have an arcuate shape in horizontal section.

7. The cleaning container according to any one of claim 4, characterized in that said indentations (4) in vertical section have an upper arcuate first section (5), a subsequent, outwardly recessed holding section (6) of a short length for said bellows, and a lower arcuate guide section (7).

8. The cleaning container according to claim 7, characterized in that the free inner diameter of said indentations on the outer end of said holding sections (6) is slightly larger than the outer diameter of said bellows (3).
